(19) United States
(12) Patent Application Publication
(10) Pub. No.: US 2011/0269051 A1
(43) Pub. Date: Nov. 3, 2011

(54) Coated Product For Use In Electrochemical Device And A Method For Producing Such A Product

(75) Inventors: Jacques Hubert Olga Joseph Wijenberg, Amsterdam (NL); Anke Marja Berends, Alkmaar (NL); Arnoud Cornells Adriaan De Vooys, Maarssen (NL); Joost Freek Cees-Jan Martijn Reijerse, Haarlem (NL)

(73) Assignee: HILLE& MULLER GMBH

(21) Appl. No.: 13/142,307

(22) PCT Filed: Dec. 23, 2009
(86) PCT No.: PCT/EP2009/009246

§ 371 Date: Jun. 27, 2011

(30) Foreign Application Priority Data
Dec. 29, 2008 (EP) 08022480

(51) Int. Cl. B32B 15/01; H01M 8/24; B05D 5/12; H01M 8/02; C25B 9/18; C25B 9/00

(52) U.S. Cl. 429/457; 204/267; 204/279; 427/115; 427/123; 428/615; 428/650; 428/668

(57) ABSTRACT

A coated product for use in an electrochemical device including a metal sheet substrate provided with a coating system. The coating system including a first metal layer as an outer layer and a second metal coating layer as a layer between the first metal layer and the substrate. An alloy diffusion layer including the first metal and the second metal is present to provide the substrate with a corrosion resistant coating system. A method for producing the coated product and the use thereof in fuel cells or electrolysers are also disclosed.

This invention relates to a coated product for use in an electrochemical device, such as in fuel cells, electrolysers or batteries, and a method for producing such a product.

Fuel cells are electrochemical devices that convert the chemical energy of a reaction directly into electrical energy. The basic physical structure, or building block, of a fuel cell consists of an electrolyte layer in contact with a porous anode and cathode on either side. Electrolysers are electrochemical devices that convert electrical energy into chemical energy, such as the electrolysis of water into hydrogen and oxygen.

In a typical fuel cell, fuels are fed continuously to the anode and an oxidant is fed continuously to the cathode. The electrochemical reactions take place at the electrodes to produce an electric current. The fuel cell is an energy conversion device that theoretically has the capability of producing electrical energy for as long as fuel and oxidant are supplied to the electrodes. In reality, degradation, particularly of the membrane electrode assembly (MEA), corrosion, or malfunction of components limits the practical operating life of fuel cells. The electrolyte does not conduct electricity, thereby preventing short circuiting of the cell. It also provides a physical barrier to prevent the fuel and oxidant gas streams from directly mixing.

As with batteries, individual fuel cells must be combined to produce appreciable voltage levels and so are joined by interconnects. Because of the usual configuration of a flat plate cell, the interconnect is formed by a separator plate or a bipolar plate with the function to provide an electrical series connection between adjacent cells, specifically for flat plate cells, and to provide a gas barrier that separates the fuel and oxidant of adjacent cells. Interconnects must be an electrical conductor and impermeable to gases and liquids. The design of the bipolar plate is vital to the performance of the stack. The plate must be capable of effectively distributing gas or liquid to reduce transport resistance while providing the path for electronic current, removal of product water and heat conduction. Contact resistance should be minimized and therefore, if the bipolar plate is made of a metallic material, it is important that low-conducting oxide layers are not formed between the electrodes and the separator plate.

The bipolar plates are typically made of a corrosion resistant and electrically conductive material, such as stainless steel, titanium, aluminium, polymeric carbon composites, etc., so that they conduct the electricity generated by the fuel cells from one cell to the next cell and out of the stack. Metal bipolar plates typically produce a natural oxide on their outer surface that makes them resistant to corrosion. However, the oxide layer is usually not very conductive, and thus increases the internal resistance of the fuel cell, reducing its electrical performance. Plating the metallic separator plates with noble metals such as gold avoids the formation of the oxide layer, but this makes the plates very expensive.

Various processes have been proposed in the art to deposit hydrophilic and electrically conductive materials onto a bipolar plate. Typically, these processes are two step processes and are expensive. For example, one process includes first depositing a gold layer onto a stainless steel bipolar plate by a physical vapour deposition (PVD) process, and then depositing a silicon dioxide (SiO2) layer on the gold layer by a plasma enhanced chemical vapour deposition (CVD) process. Other processes include co-sputtering gold and silicon dioxide onto the bipolar plate substrate. However, all of these processes are fairly cost prohibitive.

It is an object of this invention to provide a coated product for use as a separator plate in electrochemical devices, such as fuel cells or electrolysers, or in batteries, which is resistant to corrosion, has good electrical conductivity and can be produced at low cost.

This object is reached by providing a coated product comprising a metal sheet substrate provided with a coating system, said coating system comprising a first metal layer, such as a chromium layer, as an outer layer and a second metal layer, such as a nickel-containing coating layer comprising or consisting substantially of nickel or a nickel-alloy, as a layer between the first metal layer and the substrate, and wherein an alloy diffusion layer comprising the first and the second metal, such as nickel and chromium, is present so as to provide the substrate with a corrosion resistant coating system. For example, by providing a nickel and chromium diffusion layer, the metal sheet substrate is provided with a coating system having the characteristics of a nickel-chromium alloy in the diffusion layer. It should be noted that e.g. the second metal may be a single metal, such as nickel, but it may also be an alloy, such as nickel-molybdenum. In the context of this description, outer is defined as the farthest removed from the substrate. In most cases the outer layer is also the outermost layer, and therefore contacting the prevailing environment. In the context of this invention fuel cells, such as PEM fuel cells, are deemed to comprise not only the Nafion-type (Low Temperature PEMFC) and H₃PO₄-impregnated-into-a-carrier-membrane-type fuel cell (High Temperature PEMFC) but also the H₃PO₄-impregnated-into-a-Polybenzimidazole-carrier-membrane fuel cell (High Temperature PEMFC) and other types currently under development. The invention is therefore not limited to the aforementioned specifically mentioned fuel cell types only, but also comprises other electrochemical devices such as batteries and electrolysers, where electrolysers can for instance be fuel cells operating in a reverse manner (under applied potential). Polymer Electrolyte Membrane (PEM) fuel cells, also called Proton Exchange Membrane fuel cells, are the type typically used in automotive applications. Also in the context of this invention a nickel-containing layer is a layer in which nickel is intentionally present. It may be a layer consisting substantially or totally of nickel, or a layer comprising nickel, such as a nickel-alloy layer. In the context of this invention the term corrosion resistant coating system is deemed to mean corrosion resistant against the conditions under the prevailing conditions in the fuel cell.

Depending on the thickness of the various layers in the coating system, and the duration and annealing temperature used during the diffusion annealing treatment, the diffusion layer may be limited to the region of the interface between the first metal layer and the second metal layer, but the diffusion layer may also extend over more than one layer or even all layers of the coating system thereby effectively producing a coating system of which a large part or all shows a concentration gradient of the various metals which were present in the individual layer prior to the diffusion annealing. Diffusion of the substrate into the coating system and vice versa may occur.

According to an embodiment of the invention, the metal sheet substrate comprises, or consists substantially of, an unalloyed or low-alloy steel, or a stainless steel, or aluminium or an aluminium alloy, or titanium. In order to produce a cost effective separator plate the substrate must be as cheap as possible. This is achieved by selecting a simple stainless steel, or an unalloyed or low-alloy steel, or aluminium or an aluminium alloy. These cheaper materials may not be as corrosion resistant as the commonly used stainless steels for separator plates, but the coating system according to the invention enhances the corrosion resistance of the cheaper steels to the level of that of the more expensive stainless steel commonly used for separator plates.

According to an embodiment of the invention the metal sheet substrate is provided with a nickel-containing layer between the substrate and the second metal layer and wherein the nickel-containing layer is a nickel-layer, a nickel-molybdenum alloy layer, a nickel-chromium alloy layer, or a nickel-molybdenum-chromium alloy layer. In this embodiment, the corrosion resistance of the alloy which is formed during diffusion annealing is even further improved. By the introduction of molybdenum in the alloy the properties of alloys such as HasteHoy® C.-2000, a commercial alloy for application in acid environments, supplied by Haynes International, Inc can be achieved. This way, the properties of an expensive alloy can be emulated by applying a suitable coating system on a much cheaper substrate and subsequently annealing this coating system. Additional alloying elements, such as copper, can be added to the coating system by adding an additional plating layer before annealing.

According to an embodiment of the invention the second metal layer, such as a nickel-containing layer, comprises a spatial distribution of conductive particles such as conductive ceramic particles or carbon particles such as graphite particles. In this embodiment, the electrical conductivity of the coating system is increased by the incorporation of the particles in the second metal layer. Since these particles are inert, they will remain largely in place during the annealing step and hence still provide the increased electrical conductivity after the annealing step.

In an embodiment of the invention the metal sheet substrate is provided with a nickel-containing layer between the substrate and the second metal layer. In this embodiment the nickel-containing layer is mainly intended to provide an improved adhesion of the coating system to the metal substrate. For this nickel-containing layer a so-called Woods nickel strike may be used. Another purpose of this nickel-containing layer may be to increase the nickel content in the alloy diffusion layer.

In a second aspect a method for producing a coated product in accordance with the invention is provided wherein a metal sheet substrate is provided with a coating system of at least a second metal layer by a first application step and a first metal layer by a second application step, and wherein said coating system is subjected to a diffusion annealing operation so as to induce the formation of an alloy diffusion layer comprising at least the first metal and the second metal. In the context of this invention, the second metal layer is always between the first metal layer and the substrate, but there may be additional layers between the second metal layer and the substrate.

According to an embodiment of the invention the metal sheet substrate is an unalloyed or low-alloy steel or a stainless steel or aluminium or an aluminium alloy or titanium. In order to produce a cost effective separator plate the substrate must be as cheap as possible. This is achieved by selecting a simple stainless steel or even an unalloyed or low-alloy steel. These cheaper steels may not be as corrosion resistant as the commonly used stainless steels for separator plates, but the coating system according to the invention enhances the corrosion resistance of the cheaper steels to the level of that of the more expensive stainless steel commonly used for separator plates. Said steel types can be provided in the form of plate, sheet or a coiled strip. The application steps are preferably by means of a plating operation and are preferably performed in continuous coating lines such as electroplating lines. However, the application steps may also be performed by other coating techniques such as electroless plating, PVD, CVD, plasma-coating etc.

According to an embodiment of the invention the metal sheet substrate is provided with a chromium-containing layer as the first metal layer and a nickel-containing layer as the second metal layer, and wherein the alloy diffusion layer comprises nickel and chromium. The Ni—Cr-alloy diffusion layer provides a stainless-steel-like corrosion resistance to the coating system.

According to an embodiment of the invention the metal sheet substrate is provided with a nickel-containing layer between the substrate and the second metal coating layer by an application step wherein the nickel-containing layer is a nickel-layer, a nickel-molybdenum alloy layer, a nickel-chromium alloy layer, or a nickel-molybdenum-chromium alloy layer. It will be clear that this additional layer is provided to the substrate prior to the application of the second metal coating layer.

According to an embodiment of the invention the second metal layer, such as a nickel-containing layer, is provided with a spatial distribution of conductive particles. As an additional component, the electroplating bath contains electrically conductive particles such as, for example, elemental carbon as fine carbon, graphite or carbon black or, for example, titanium disulfide, tantalum disulfide or molybdenum silicide or mixtures thereof, which are co-deposited on the base material together with the metal of the second metal layer, such as nickel, during electroplating. The second metal with which electrically conductive particles can be co-deposited are nickel, chromium, cobalt, iron, molybdenum, tungsten, zinc, copper, gold, silver, platinum or mixtures or alloys thereof. However, for economical reasons, it is preferable to use a nickel-containing metal layer to co-deposit the particles with.

These dispersed conductive particles reduce the resistance of the coating layer in which they are dispersed. When carbon in the form of graphite particles is used, the carbon content of the electroplated coating is preferably between about 0.7% and 15%. A further embodiment of the invention proposes that the electroplating bath contains suspension stabilizing and/or coagulation reducing substances in order to achieve a uniform distribution of the electrically conductive particles. It may also be advantageous to provide the electroplating bath with stabilizing and/or coagulation reducing substances that result in hard brittle coatings, as is the case, for example, with so-called brighteners. Furthermore, the added substances can also act as brightening or pore reducing agents.

According to an embodiment of the invention the method comprises the production of a blank for producing a separator plate by a forming operation, and wherein one, more or all of the three application steps and/or the diffusion annealing step take place only after the separator plate has been formed in the forming operation. Although the application operation and annealing, such as a plating operation and a continuous annealing process, is likely to be cheaper when performed in a continuous plating and/or annealing line, and the blanking operation is then subsequently performed from the coated steel substrate, it may be convenient to produce the blank from an uncoated substrate and provide the coating system on the formed blank. The annealing operation is also likely to be cheaper when performed in a continuous annealing line, but there may be advantages in performing the annealing on the coated and formed separator plate. One of these advantages is that when the plating is performed on the formed separator plate that the cut edges of the plate are also plated and thus also protected against corrosion. When forming the separator plate from a blank stamped from a continuously plated and annealed strip, the substrate metal is bare at the cut edges and may need to be protected against corrosion or the design of the fuel cell must be such that the cut edges do not come into contact with the corrosive environment prevailing in the fuel cell.

In an embodiment the formed coated product is produced by a forming operation, and wherein the application steps and the diffusion annealing step take place before the formed coated product is formed in the forming operation.

The annealing operation preferably takes place in a protective gas atmosphere at a temperature ranging from 550° C. to 1100° C. as a function of type of substrate used. For a low alloy or unalloyed steel, the annealing temperature preferably does not exceed 920° C. to avoid re-austenitisation. The annealing may also cause microstructural changes such as recovery, recrystallisation or ageing of the substrate and it may cause the deposited metal of the second metal layer or the constituents of any layers between the second metal layer and the substrate to diffuse into the base material. This may result in an improved adhesion of the coating system to the substrate during forming. The annealing time is chosen in dependence of the desired diffusion layer thickness and composition. When a lower annealing temperature is chosen, or has to be chosen, for instance in case of a low melting substrate such as aluminium, the annealing time can be chosen correspondingly longer because in case of a diffusion processes, the required time and temperature are coupled.

In a third aspect of the invention a fuel cell, such as a PEM fuel cell, comprising a stack of fuel cells separated by separator plates according to the invention and/or produced by the method of the invention is provided.

In a non-limiting example a plain carbon steel is coated with a nickel plating layer from a Watts-type nickel bath. The electroplating bath comprises not only Ni-ions but also conductive particles of fine carbon, graphite, carbon black, tantalum disulfide, titanium disulfide or molybdenum silicide finely distributed in the form of a suspension with a particle size ranging from 0.5 to 15 μm, and are kept in suspension by strong agitation of the electrolyte bath. During electrolytic treatment of the cold-rolled sheet metal, following optional prior degreasing, rinsing, pickling, rinsing, etc., a joint deposition of both the aforementioned elements and the conductive particles is formed on the surface. Additives to the plating bath may be used to keep the suspension uniform and prevent flocculation and coagulation of the particles.

The mass transfer rate in a strip plating line may also be enhanced by increasing the line speed or by agitation, by which the thickness of the diffusion layer adjacent to the moving strip is reduced. Agitation can be realised by means of eductors or by introducing a moving or rotating body between the moving strip and the anodes. Examples of means to enhance the mass transfer rate during electrodeposition are disclosed in EP1278899, the contents of which are hereby included by reference, particularly sections [0008] to [0026].

A cold-rolled steel strip can be treated in a strip plating plant for instance by degreasing, rinsing, pickling, rinsing, followed by nickel plating in a Watts-type nickel bath comprising 60 g/l Ni₂SO₄, 30 g/l NiCl₂, Boric acid 40 g/l, Graphite 40 g/l of grain size 1-8 μm at a pH of 2.3, a bath temperature of 60° C. and a current density of 15 A·dm⁻², turbulent agitation and electrolyte flow 6-10 m/s. Suspension stabilizing and coagulation preventing substances can be, for example, condensation products of formaldehyde and naphtalenesulfonic acid, furthermore ethylene glycol and ethylene alcohol. The nickel layers produced as specified above may measure 0.2-8 μm and the graphite content in the nickel layer is 0.7-15%.

Subsequently, a 1 μm Cr-layer was deposited on top of the Ni-layer from a 250 g/l CrO₃, 1.2 g/l sulphate, 4 g/l H₂SiF₆ (55° C., 50 A·dm⁻²) plating solution. The multi-layer coating system was subsequently subjected to diffusion annealing in a reducing atmosphere at 900° C. for 9 minutes in a 100% H2(g) gas atmosphere and a dewpoint below −50° C.

In an embodiment the nickel alloy coating layer comprises nickel and molybdenum which is deposited onto the substrate from an aqueous solution comprising nickel salts, gluconate anions, citrate anions and molybdate and wherein the pH of the solution is adjusted between 5.0 and 8.5. Preferably a stress reliever such as ammonium sulphate or ammonium molybdate is added to the plating bath. The gluconate and citrate may be added to the solution as sodium gluconate and sodium citrate. The nickel salt may be added as nickel sulphate and/or nickel chloride. The molybdate, such as sodium molybdate, is preferably added at a concentration of 0.008 mol/l to 0.10 mol/l. Preferably the aqueous solution comprises between 0.005 and 0.5 mol/l sodium gluconate. It was found that the plating bath is preferably maintained at a temperature between 30 and 80° C., preferably between 40 and 70° C., more preferably between 45 and 65° C. Excellent current efficiency is achieved when the cathodic current density is chosen such that the current efficiency is at least 30%. This is achieved when the cathodic current density is at least 8.5 A/dm², more preferably at least 10 A/dm². Preferably the cathodic current density is at least 12.5 A/dm² and at most 40 A/dm², preferably wherein the cathodic current density is between 15 A/dm² and 30 A/dm². It was found that agitation of the plating bath, causes an increase of the mass transfer rate and an increase of the Mo-content in the Ni—Mo alloy.

As an example of a suitable plating bath for depositing a Ni—Mo-alloy plating layer, the aqueous solution comprises

0.53 to 1.06 mol/l NiSO₄

0.028 to 0.68 mol/l NiCl₂

0.008 to 0.08 mol/l alkali metal molybdate

0.45 to 0.54 mol/l sodium citrate

0.023 to 0.207 mol/l sodium gluconate

0.055 to 1.33 mol/l ammonium e.g. as ammonium sulphate

pH between 5.75 and 7.25.

More specifically the aqueous solution comprises:

| | concentration | |
|---|---|---|
| Compound | g/l | M (or mol/l) |
| NiSO₄ (×6 H₂O) | 142 | 0.540 |
| NiCl₂ (×6 H₂O) | 30 | 0.126 |
| Sodium molybdate (×2 H₂O) | 12.1 | 0.050 |
| Ammoniumsulphate | 34 | 0.257 |
| Tri-sodium citrate (×3 H₂O) | 140 | 0.476 |
| Sodium gluconate | 30 | 0.138 |

pH = 6.1 ± 0.2

The invention is further explained by reference to the following schematic, non-limiting examples of coating systems to be provided upon the metal substrate.

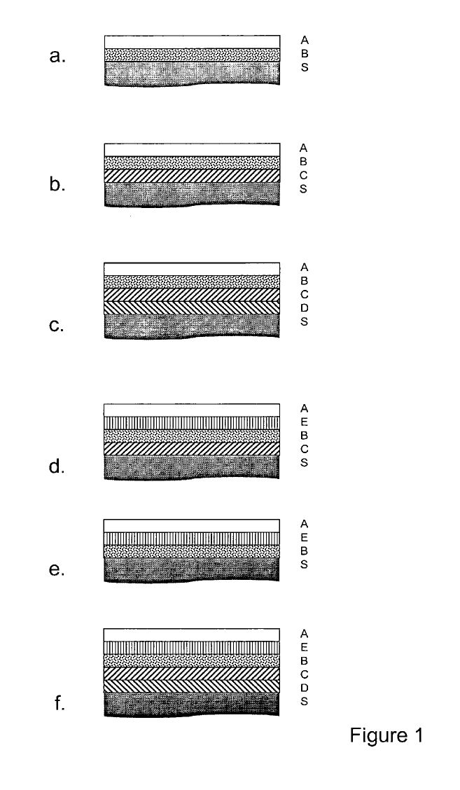

In FIG. 1a to f examples of coating systems are given which are in accordance with the invention. For the sake of clarity these systems are shown prior to the diffusion annealing so that the individual layers are still clearly distinguishable. In these coating system the following layers may be present:
A: metal layer such as a chromium layer
B: metal layer comprising carbon particles (optional) such as a nickel or nickel containing layer
C: nickel or nickel containing layer (essential if layer B is absent, otherwise optional), the layer optionally comprising carbon particles
D: metal layer e.g. Cr, Mo, . . . (optional)
E: metal layer e.g. Cr, CrMo, CuNi, Ni, Mo, Cu, Zr, Co, Mn, Ti, Ag, W, Si, Ta, Au, Pt (optional)
S: Metal substrate (essential)

FIG. 1a is the example wherein the substrate is provided with a first metal layer A and a second metal layer B which optionally comprises a spatial distribution of conductive particles such as conductive ceramic particles or carbon particles, such as graphite particles. The diffusion annealing layer will be formed on the interface between layer A and B. Preferably layer A is a chromium-containing layer and layer B is a nickel- or nickel-molybdenum-containing layer.

FIG. 1b is the embodiment wherein an additional metal layer is provided between the second metal layer B which optionally comprises a spatial distribution of carbon particles and the substrate. Preferably first metal layer A is a chromium containing layer and second metal layer B is a nickel- or nickel-molybdenum containing layer. In a preferable embodiment layer C is a nickel-containing layer, such as a Watts nickel layer or a Woods nickel strike. The presence of this layer enables to produce a diffusion layer with a higher nickel content. It may also serve to improve the adhesion of layer B to the substrate.

FIG. 1c is the embodiment wherein a further metallic layer is provided below the layer C of the embodiment presented in FIG. 1b. This further metallic layer enables the production of specific alloys during the diffusion annealing.

The embodiments of FIGS. 1d to 1f are those of FIGS. 1a to 1c respectively with an additional metal layer between the first metal layer A and the second metal layer comprising the carbon particles. This layer is mainly intended to provide the alloying elements for the diffusion annealed alloy layer, but there may also be other reasons to add the additional layer such as adhesion properties.

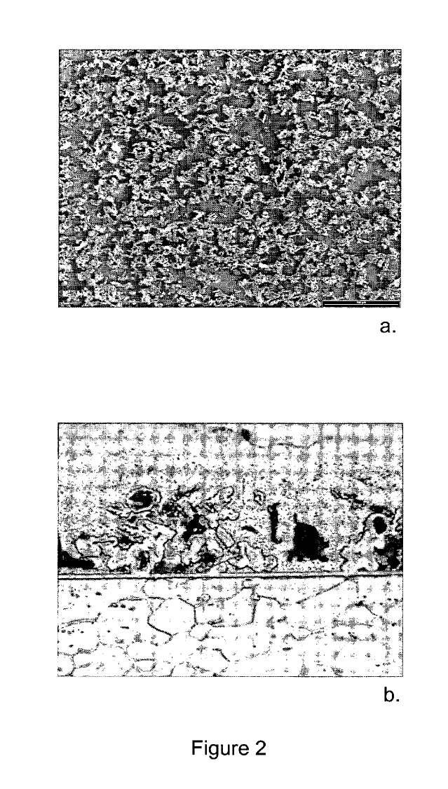

The presence of a first metal layer (layer A) and at least layer B or C is required, because of the formation of the diffusion layer in the coating system. In a preferable embodiment first metal layer A is a chromium containing layer, and second metal layer B or C is preferably a nickel-containing layer, thus allowing the formation of a Ni—Cr diffusion layer in between those layers. In an embodiment the Ni-containing layer comprises carbon particles (see FIG. 2 for an example hereof). In a preferable embodiment the Ni-containing layer also comprises molybdenum. This Ni—Mo layer is preferably deposited by electroplating from the aqueous solution comprising nickel salts, gluconate anions, citrate anions and molybdate as described hereinabove.

In the embodiments a layer A and/or C is present in combination with a layer B comprising the carbon particles, said layer A and/or C comprising one or more of the following elements such as Ni, Cr, Mo, Cu, Zr, Co, Mn, Ti, Ta, W, Si, Ag, Au and Pt or alloys thereof. Examples of alloys comprising one or more of these elements are Hastelloy B-2, Cupronickel 80-20, Cupronickel 70-30, Everdur 1010, Monel K500, Hastelloy C-276, MA-B2, MA276, MA20NB3, 904L, Aluminiumbronze, and higher grades stainless steels.

In the embodiments where layer B is present, instead of layer C as defined above, a layer C′ may be present comprising alloys such as Hastelloy B-2, Cupronickel such as Cu80-Ni20 or Cu70-Ni30, Aluminium-Bronze, Everdur 1010, Monel K500, Hastelloy C-276, MA-B2, MA276, MA20NB3, 904L, higher grades stainless steels or elements such as Ni, Cr, Mo, Cu, Zr, Co, Mn, Ti, Ag, Au, Ta, W, Si, Pt.

Layer E will mainly be used when there is a desire to add alloying elements which will be incorporated in the alloy diffusion layer.

FIG. 2a provides a top view of a nickel layer comprising carbon particles and FIG. 2b provides a cross section thereof.

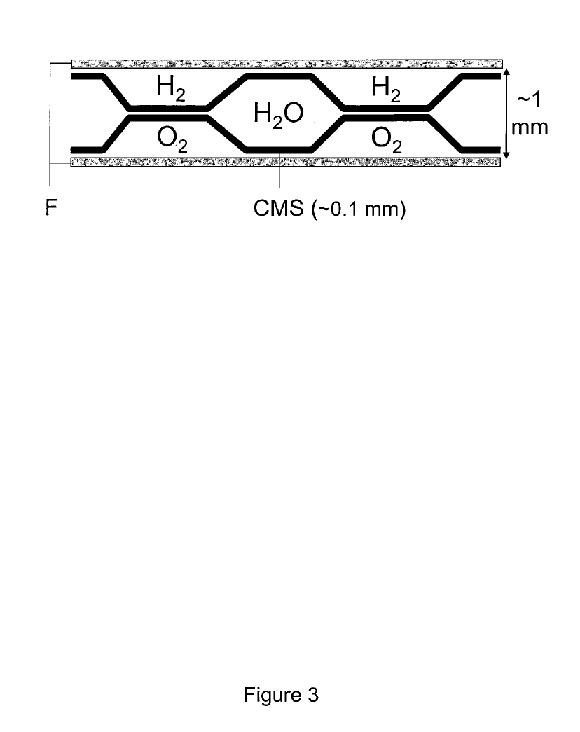

FIG. 3 provides a schematical view of two separator plates (CMS, coated metal sheet) provided with a coating system in accordance to the invention on at least the side not contacting the coolant (in this example water is used as coolant) wherein these plates typically have a thickness of about 0.1 mm, and two gas diffusion layers or membrane electrode assembly (MEA) (F). the total thickness of the system in FIG. 3 is about 1 mm.

1. A coated product for use in an electrochemical device comprising a metal sheet substrate provided with a coating system, said coating system comprising a first metal layer as an outer layer, said first metal layer comprising a first metal, and a second metal coating layer as a layer between the first metal layer and the substrate, said second metal layer comprising a second metal, and wherein an alloy diffusion layer comprising the first metal and the second metal is present to provide the substrate with a corrosion resistant coating system, wherein the first metal layer is a chromium containing layer and the second metal layer is a nickel- or nickel-molybdenum-containing layer and wherein the alloy diffusion layer comprises at least nickel and chromium.

2. A coated product according to claim 1, wherein the coated product is a separator plate for use in a fuel cell, or a separator plate for an electrolyser, or a product for application into a battery.

3. A coated product according to claim 1, wherein the second metal layer comprises a spatial distribution of conductive particles.

4. A coated product according to claim 1, wherein the metal sheet substrate is selected from a member of the group consisting of an unalloyed steel, low-alloy steel, a stainless steel, aluminium, aluminium alloy, and titanium.

5. A coated product, according to claim 3, wherein the metal sheet substrate is provided with a cobalt-containing layer between the substrate and the second metal layer.

6. A coated product, according to claim 1, wherein the metal sheet substrate is provided with a nickel-containing layer between the substrate and the second metal layer and wherein the nickel-containing layer is a nickel-layer, a nickel-molybdenum alloy, a nickel-chromium alloy, or a nickel-molybdenum-chromium alloy layer.

7. A method for producing a coated product according to claim 1, wherein a metal sheet substrate is provided with a coating system of at least a second metal layer by a first application step and first metal outer layer by a second application step, and wherein said coating system is subjected to a diffusion annealing operation to induce the formation of an alloy diffusion layer comprising at least the first metal and the second metal.

8. A method according to claim 7, wherein the coated product is a separator plate for use in a fuel cell, or a separator plate for an electrolyser, or a product for application into a battery.

9. A method according to claim 7, wherein the second metal layer is provided with a spatial distribution of conductive particles.

10. A method according to claim 7, wherein the metal sheet substrate is selected from a member of the group consisting of an unalloyed steel, low-alloy steel, a stainless steel, aluminium, an aluminium alloy, and titanium.

11. A method according to claim 7, wherein the first metal layer is a chromium containing layer and the second metal layer is a nickel- or nickel-molybdenum-containing layer and wherein the alloy diffusion layer comprises at least nickel and chromium.

12. A method according to claim 7, wherein the metal sheet substrate is provided with a nickel-containing layer between the substrate and the second metal layer by an application step wherein the nickel containing layer is a nickel layer, or a nickel-molybdenum alloy, a nickel-chromium alloy, or a nickel-molybdenum-chromium alloy layer.

13. A method according to claim 7, comprising the production of a formed coated product by a forming operation, and wherein one, more or all of the application steps and/or the diffusion annealing step take place only after the formed coated product has been formed in the forming operation.

14. A method according to claim 7, comprising the production of a formed coated product by a forming operation, and wherein the application steps and the diffusion annealing step take place before the formed coated product is formed in the forming operation.

15. A fuel cell or an electrolyser comprising a stack of fuel cells separated by separator plates according to claim 2.

16. A coated product according to claim 1, wherein the second metal layer comprises a spatial distribution of conductive particles selected from at least one member of the group consisting of conductive ceramic particles and graphite.

17. A coated product according to claim 5, wherein the coated product is a separator plate for use in a fuel cell, or a separator plate for an electrolyser, or a product for application into a battery.

18. A coated product according to claim 6, wherein the coated product is a separator plate for use in a fuel cell, or a separator plate for an electrolyser, or a product for application into a battery.

19. A method according to claim 9, wherein the second metal layer is provided with the spatial distribution of conductive particles, wherein the second metal layer is a nickel-containing layer.

20. A method according to claim 19, wherein the conductive particles comprise graphite.

21. A fuel cell or an electrolyser comprising a stack of fuel cells separated by separator plates produced by the method of claim 8.
